(19) United States
(12) Patent Application Publication
(10) Pub. No.: US 2015/0082951 A1
(43) Pub. Date: Mar. 26, 2015

(54) CUSTOMIZABLE TOOL

(71) Applicant: James Martin, West Des Moines, IA (US)

(72) Inventor: James Martin, West Des Moines, IA (US)

(21) Appl. No.: 14/494,814

(22) Filed: Sep. 24, 2014

Related U.S. Application Data
(60) Provisional application No. 61/881,607, filed on Sep. 24, 2013.

(51) Int. Cl. B25G 1/10

(52) U.S. Cl. CPC B25G 1/10
USPC 81/489

(57) ABSTRACT

A customizable hand tool system is presented. The customizable hand tool system includes a blade which is connected to an inner frame. The inner frame extends a length between a first end and a second end and includes a front stop positioned adjacent the front end and a rear stop positioned adjacent the second end. A cover is positioned around the inner frame between the front stop and the rear stop. A label, which the user or owner can customize, is positioned between the inner frame and the cover. As the cover is transparent or translucent, the label is easily seen through the cover. In this way, presented is a customizable hand tool that prevents misplacement or theft of the hand tool.

### CROSS REFERENCE TO RELATED APPLICATION

This application claims the benefit of U.S. Provisional Application No. 61/881,607 filed Sep. 24, 2013.

### BACKGROUND OF THE INVENTION

This invention relates to a customizable hand tool. More specifically and without limitation, this invention is directed towards a system for modifying the appearance of a handle of a hand tool.

Hand tools are old and well known in the art. Countless forms of hand tools exist which are used by craftsmen in countless ways for an unlimited amount of purposes. Conventionally, hand tools have a basic a handle the appearance of which cannot be easily altered. While this arrangement is effective it has a number of disadvantages. Namely, this causes one set of hand tools to be indistinguishable from other hand tools of the same kind.

This often results in unintentional mistakes in ownership. In addition, when one's hand tool is misplaced, lost, or found by another, conventionally, there is no way to determine the true ownership of the hand tool so that the hand tool can be returned to the owner.

Thus it is a primary objective of the invention to provide a hand tool system that improves upon the state of the art.

Another object of the invention is to provide a hand tool system that reduces misidentification.

Yet another object of the invention is to provide a hand tool system that reduces theft.

Yet another object of the invention is to provide a hand tool system that increases recovery when lost.

Another object of the invention is to provide a hand tool system that allows for personalization.

Yet another object of the invention is to provide a hand tool system that allows for repeated modification.

Another object of the invention is to provide a hand tool system that is inexpensive.

Yet another object of the invention is to provide a hand tool system that is easy to use.

Another object of the invention is to provide a hand tool system that is durable.

Yet another object of the invention is to provide a hand tool system that provides a long and useful life.

Another object of the invention is to provide a hand tool system that has an intuitive design.

Yet another object of the invention is to provide a hand tool system that has a minimum number of parts.

Another object of the invention is to provide a hand tool system that is simple.

These and other objects, features, or advantages of the inventions will become apparent from the specification and claims.

### SUMMARY OF THE INVENTION

A customizable hand tool system is presented. The customizable hand tool system includes a blade which is connected to an inner frame. The inner frame extends a length between a first end and a second end and includes a front stop positioned adjacent the front end and a rear stop positioned adjacent the second end. A cover is positioned around the inner frame between the front stop and the rear stop. A label, which the user or owner can customize, is positioned between the inner frame and the cover. As the cover is transparent or translucent, the label is easily seen through the cover. In this way, presented is a customizable hand tool that prevents misplacement or theft of the hand tool.

### BRIEF DESCRIPTION FO THE DRAWINGS

FIG. 1 is a perspective view of the customizable hand tool system;

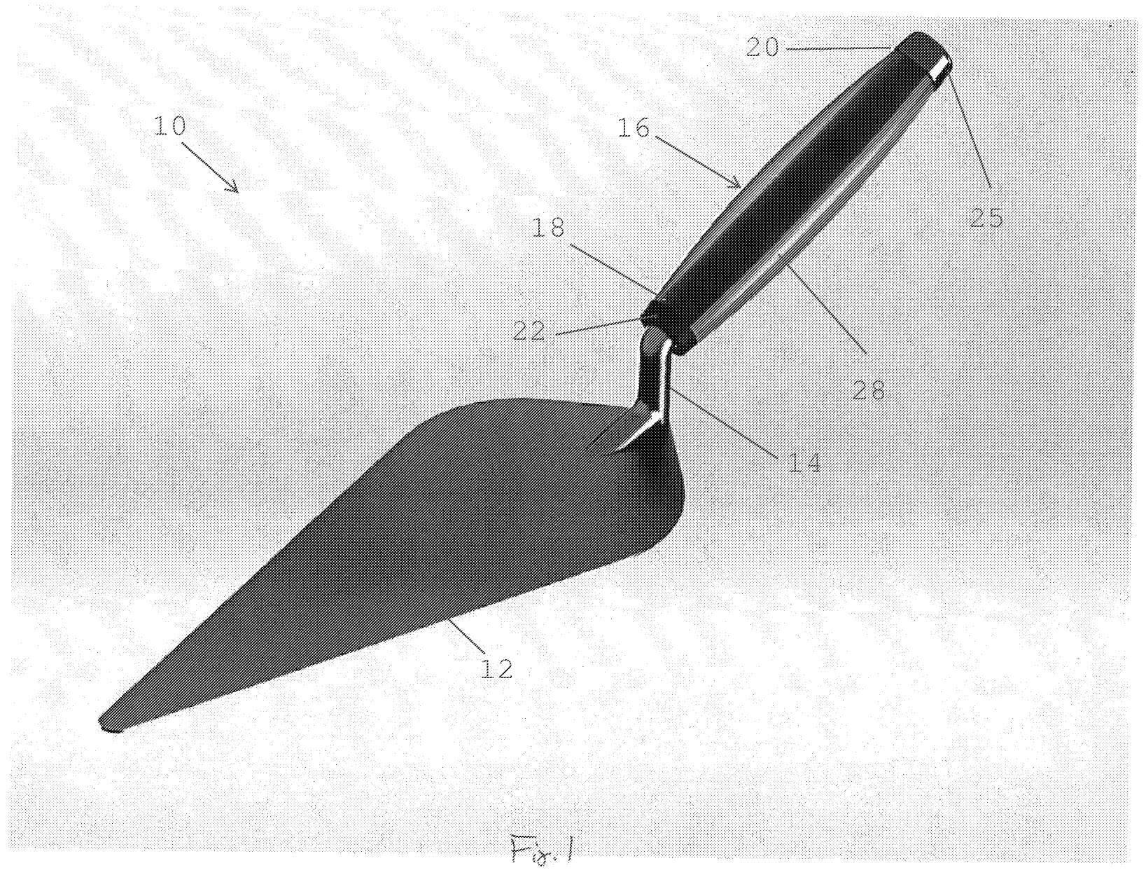

FIG. 2 is a perspective exploded view of the customizable hand tool system;

FIG. 3 is a top perspective view of the customizable hand tool;

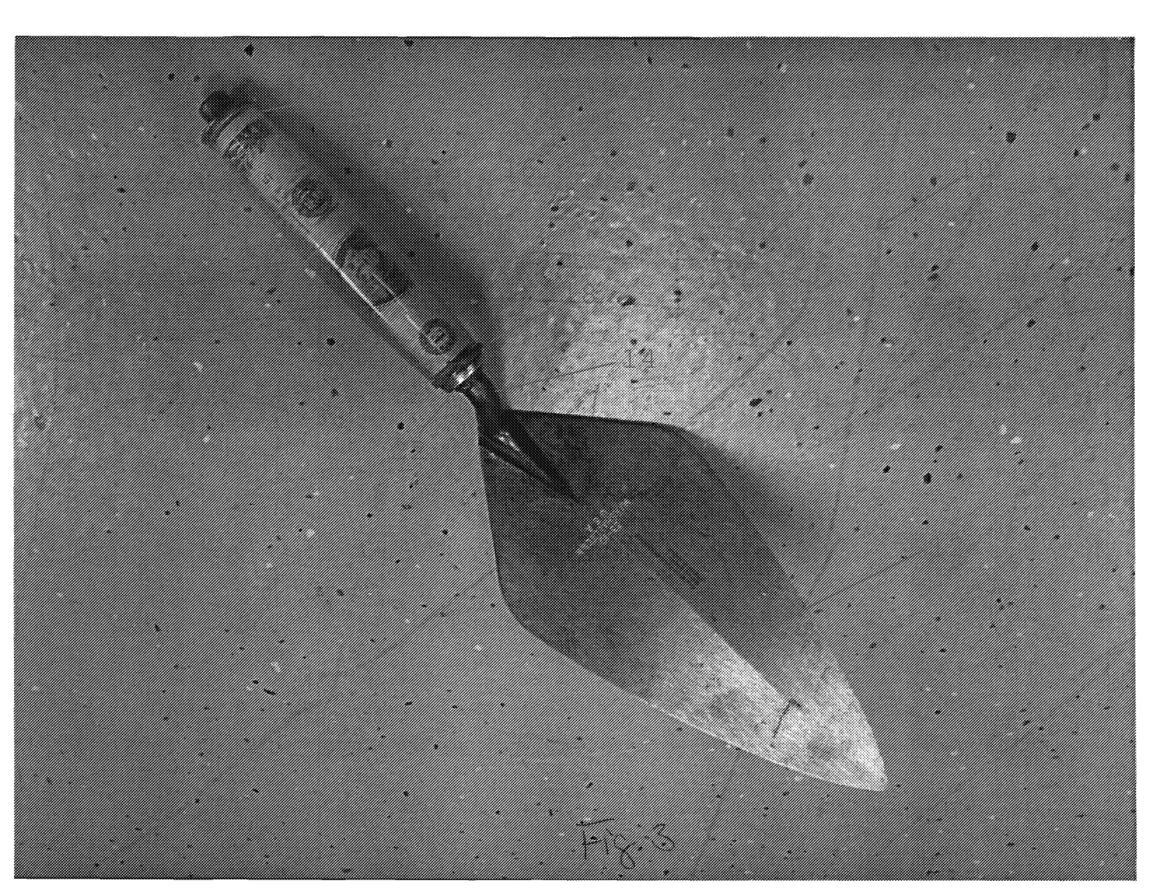

FIG. 4 is a top perspective view of the customizable hand tool with the handle disassembled.

### DETAILED DESCRIPTION OF THE PREFERRED EMBODIMENTS

In the following detailed description, reference is made to the accompanying drawings which form a part hereof, and which is shown by way of illustration specific embodiments in which the invention may be practiced. These embodiments are described in sufficient detail to enable those skilled in the art to practice the invention, and it is to be understood that other embodiments may be utilized and that mechanical, procedural, and other changes may be made without departing from the spirit and scope of the invention. The following detailed description is, therefore, not to be taken in a limiting sense, and the scope of the invention is defined only by the appended claims, along with the full scope of equivalents to which such claims are entitled.

As used herein, the terminology such as vertical, horizontal, top, bottom, front, back, end, sides, and the like, are referenced according to the views presented. It should be understood, however, that the terms are used only for purposes of description, and are not intended to be used as limitations. Accordingly, orientation of an object or a combination of objects may change without departing from the scope of the invention.

With reference to the figures, a customizable hand tool system 10 is presented. Any variation of a hand tool is hereby contemplated for use in the system such as a rake, shovel, trowel, screwdriver, hammer, wrench, pliers, etc., and without limitation. In addition, the system 10 has applicability outside of mere hand tools and instead applies to any object, system or device which has a handle.

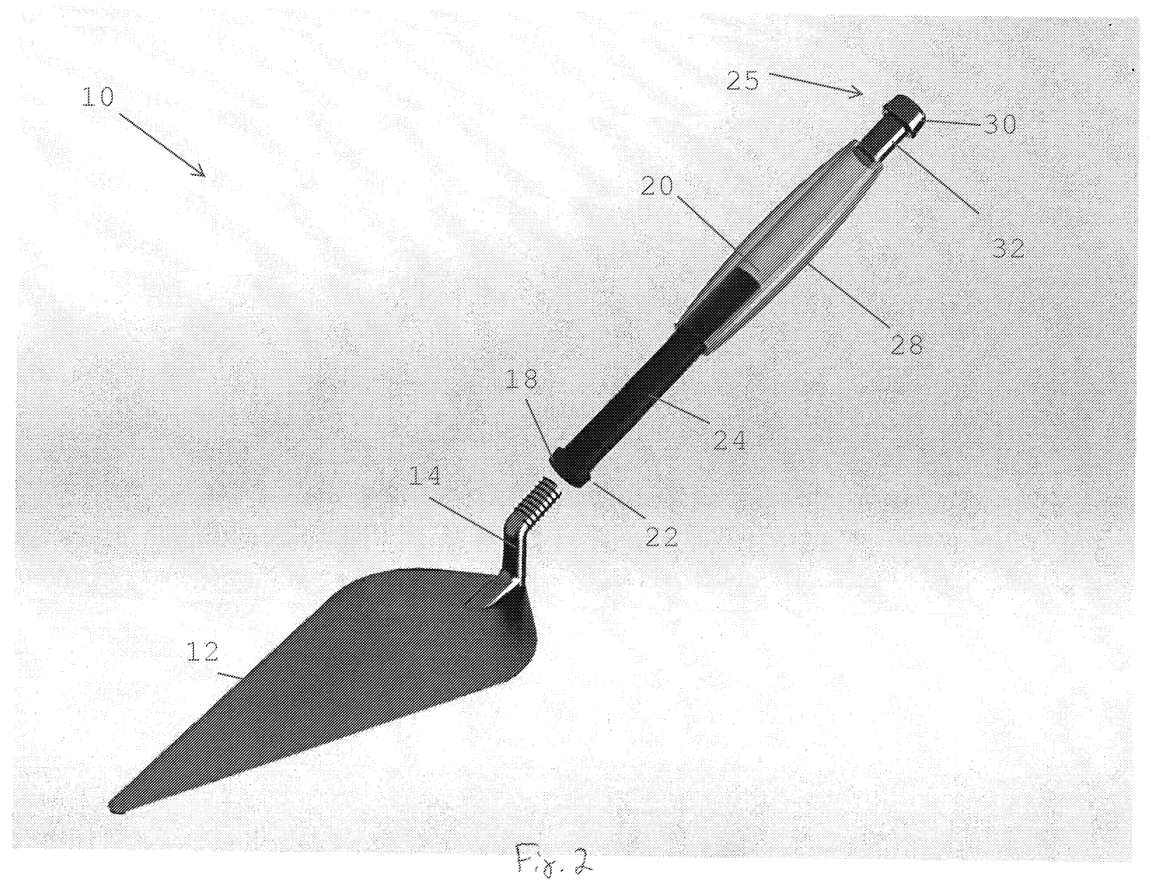

In the embodiment shown, the hand tool system 10 includes a blade 12. The blade 12 is connected to an elbow 14. In the arrangement shown, as one example, blade 12 is in the form of a mason's trowel blade, however any other form of a blade or tool is hereby contemplated such as a flat or Philips head. The elbow 14 connects to a handle 16 having a first end 18 and a second end 20. In another arrangement, as is shown in FIG. 2, elbow 14 has a threaded portion that threadadly connects to the handle 16. In an alternative arrangement, elbow 14 is connected to blade 12 in any other manner, such as permanently connecting elbow 14 to blade 12 by welding, by forming the two components 12, 14 out of a single piece of material, snap fitting, frictional engagement, or the like.

A front stop 22 and is positioned adjacent the first end 18 of the handle 16. In the arrangement shown, front stop 22 is connected to and positioned around an inner frame 24. Inner frame 24 extends a length in a direction opposite blade 12 from front stop 22. As is shown, front stop 22 has a larger outer diameter than inner frame 24. In one embodiment shown, the front stop 22 and the inner frame 24 are welded together or formed of a single piece of material. Alternatively, the front stop 22 and inner frame 24 are formed of separate components. In this arrangement, front stop 22 is connected to inner frame 24 by method or means such as threading, welding, frictional engagement, press fitting, snap fitting, adhesively bonding, or the like are hereby contemplated.

The inner frame 24 is formed of any suitable size, shape, and design and serves to provide structural rigidity to the system 10 such that a user may adequately manipulate blade 12 to serve the user's desired purpose. In the arrangement show, inner frame 24 is formed of a generally cylindrical or tubular member which extends a length between a first end 18, which is positioned adjacent to or connected to the front stop 22, and a second end 20, which is positioned adjacent to or connected to a rear stop 25.

In the arrangement shown, inner frame 24 has a hollow interior to reduce the weight of system 10 as well as reduce the raw material costs of the system 10. In addition the hollow interior provides for a convenient area for attachment of other components, such as through threading, snap fitting, press fitting, frictional engagement, or the like. Alternatively, inner frame 24 is formed of any other size, shape, and design such as a square or rectangular post, an I-beam, or any other object or device or design that provides adequate strength and rigidity to system 10.

A label 26 is connected to or positioned around the inner frame 24. Label 26 is formed of any suitable material that can be removably inserted, removed and/or replaced around inner frame 24 or/or within handle 16. Suitable materials for use as label 24 include paper, cloth, plastic, metal, composite, and the like. In an alternative arrangement, the label 26 is non-removable and is therefore permanently or semi-permanently affixed to the exterior surface of inner frame 24, such as by spraying, adhesively attaching, painting, molding or the like.

A cover 28 is removably positioned around the label 26 and inner frame 24. In the arrangement shown, the entire cover 28 is formed of a translucent or transparent rubber, plastic, or composite-type material that allows the label 26 to be seen through all portions of cover 28. In another alternative arrangement, cover 28 includes portions which are transparent or translucent, (such as windows) so as to enable sight of label 26, whereas other portions of cover 28 are not transparent or translucent. In other yet another arrangement, however, the cover 28 can have a design or have a texture of its own.

Cover 28 is formed of any suitable size, shape, and design and is formed of any suitable material. In the arrangement shown, cover 28 has a generally tubular form which extends from first end 18 to second end 20. The inner diameter of cover 28 is sized and shaped to receive the inner frame member 24 with close tolerances such that inner surface of cover 28 frictionally engages and tightly holds onto the outer surface of inner frame 24. As is also shown, the exterior diameter of cover 28 bows out at its middle and tapers at its first end 18 and opposite second end 20. This ergonomic design provides a comfortable feel and grip to the system 10 and improves ease of use. Alternatively, cover 28 is form fitting to a user's hand and in this arrangement has a plurality of protrusions and grooves which are sized and shaped to receive a user's fingers in a fitting and comfortable position.

In one arrangement, cover 28 is formed of a material that is at least somewhat compressible so as to further provide a comfortable feel for a user. In another arrangement, cover 28 is formed of more than one type of material. In this arrangement, portions of cover 28 are more or less compressible than others, such as a dual-durometer material.

In the arrangement shown, rear stop 25 is removably connected to the inner frame 24 at the second end 20 of the handle 16. As is shown, rear stop 25 has a flange 30 connected at its inward side to a shaft 32 which extends inwardly therefrom. Shaft 32 larger outer diameter than inner frame 24 whereas shaft 32 has a diameter which fits within the open interior of inner frame 24 so as to connect rear stop 25 to the system 10. In this arrangement, shaft 32 connects with inner frame 24 by any suitable means such as treading, snap fitting, frictional engagement, press fitting, or the like.

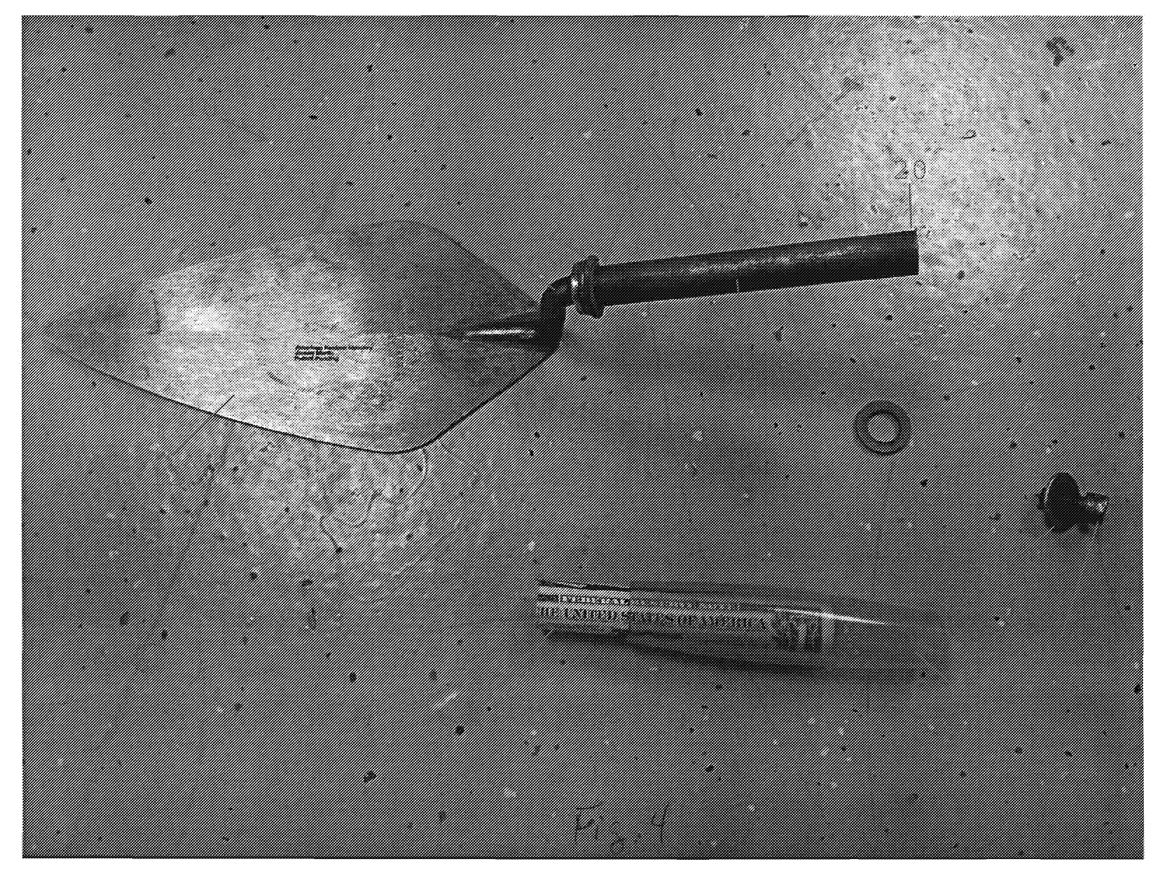

In an alternative arrangement, with reference to FIG. 4, rear stop 25 is formed of a screw or bolt 34 which connects to inner frame 24 and a washer 36 positioned between a portion of screw of bolt 34 and cover 28. Any other method of removably connecting the rear stop 25 and the inner frame 24, such as screwing, threading, snap fitting, frictional engagement, or the like are hereby contemplated.

In another arrangement, the rear stop 25 is permanently connected to the second end 20 after label 26 is connected to inner frame 24 or inserted between inner frame 24 and cover 28. Methods of connecting the rear stop 25 and the inner frame include gluing, fusing, bolting, screwing, threading, snap fitting, frictional engagement, or the like are hereby contemplated.

To provide additional give to the system 10, in one arrangement a compressible member 38 is positioned between front stop 22 and cover 28 as well as between rear stop 25 cover 28. Compressible members 38 allow for the handle 16 to be tightened and help to maintain the tightness of handle 16. In addition, compressible members 38 help to take us some of the dimensional variance between component parts of the system.

### In Operation:

A user desiring a customizable hand tool selects the system 10. Next, the user removes the rear stop 25. In one arrangement this is accomplished by unscrewing the bolt 34 and washer 36 from the inner frame 24 at the second end 20. Once the rear stop 25 is removed, the user removes the cover 28 and label 26 by sliding them laterally away from blade 12 around inner frame 24. The user modifies the label 26 such as by writing identifying information on the label 26 or replacing 26 with a customized label. Alternatively, as shown in one arrangement, the user can use anything of the same size and shape as the label 26 that is capable of wrapping around the inner frame 24. Alternatively, the user can scribe on the exterior surface of inner frame 24, paint inner frame 24, write on inner frame 24 or modify inner frame 24 by any means so as to identify the hand tool system 10 as the user's.

Now with the label 26 customized, or other marking indicia in place, the user wraps the label 26 around the inner frame 24. Next the user slides the cover 28 over the label 26 and the inner frame 24. The user then places the rear stop 25 at the second end 20 of inner frame 24 and affixes using the appropriate manner, such as screwing, snap fitting, or the like.

In another arrangement, the user removes the cover 28 as described above and replaces the cover 28 with a cover 28 of a different design, material, translucence, or grip, or a new customized cover 28 altogether.

In the arrangement wherein the system 10 is designed to prevent theft or conversion one's hand tools, it is desirable to have the rear stop 25 be non-removable once installed. That is, it reduces the effect of theft prevention if a thief can simply steal a hand tool, remove the customized label 26 and replace it with their own label 26. In this arrangement, it is desirable to have rear stop 25 and/or inner frame 24 have at least one locking member, such as a barb, flange or other member that locks rear stop 24 to inner frame 24 once the two components are connected to one another, such that the two components cannot be separated without breaking the system 10. In this way, even if the hand tool system 10 is stolen, the thief cannot remove the label 26 without destroying the tool. In this arrangement, hand tool system 10 must be sold in a disassembled state such that once it is assembled, it is assembled once and for all.

### Alternative Arrangement:

While the figures shown herein are specifically directed to a trowel-type hand tool, and more generally to hand tools, it is hereby expressly contemplated that the system and method is also applicable to cooking devices and grilling tools such as spatulas, knives, spoons, forks, skewers, tongs, brushes, and any other cooking tool or utensil. In this way, the term “tool” broadly encompasses all of these cooking tools and grilling tools as well.

From the above discussion, it will be appreciated that the customizable hand tool system presented improves upon the state of the art. That is, the customizable hand tool system presented improves upon the state of the art; reduces misidentification; reduces theft; increases returns when lost; allows for personalization; allows for repeated modification; is inexpensive; is easy to use; is durable; has a long and useful life; has an intuitive design; has a minimum number of parts; and is simple.

It will be appreciated by those skilled in the art that other various modifications could be made to the device without parting from the spirit and scope of this invention. All such modifications and changes fall within the scope of the claims and are intended to be covered thereby.

What is claimed:

1. A customizable tool system, comprising:
a blade;
the blade connected to an inner frame;
the inner frame extending a length between a first end and a second end;
a front stop connected to the inner frame adjacent the first end;
a rear stop connected to the inner frame adjacent the second end;
a cover positioned around the inner frame;
the cover positioned between and held by the front stop and the rear stop;
a label positioned between the cover and the inner frame;
wherein the label provides a customized identification of the tool.

2. The customizable tool system of claim 1 wherein the whole cover is transparent or translucent.

3. The customizable tool system of claim 1 wherein a portion of the cover is transparent or translucent.

4. The customizable tool system of claim 1 wherein the rear stop removably connects to the inner frame thereby allowing for removal and replacement of the cover and the label.

5. The customizable tool system of claim 1 wherein the rear stop has at least one locking member which locks to the inner frame when the rear stop and the inner frame are connected.

6. The customizable tool system of claim 1 wherein the inner frame has at least one locking member which locks to the rear stop when the rear stop and the inner frame are connected.

7. The customizable tool system of claim 1 wherein the inner frame and the rear stop have at least one locking member which serve to lock the rear stop and the inner frame when connected.

8. The customizable tool system of claim 1 further comprising a compressible member positioned between the front stop and the cover.

9. The customizable tool system of claim 1 further comprising a compressible member positioned between the rear stop and the cover.

10. The customizable tool system of claim 1 wherein the cover is at least partially compressible.

11. The customizable tool system of claim 1 wherein the elbow threadedly connects to the inner frame.

12. The customizable tool system of claim 1 wherein the rear stop threadedly connects to the inner frame.

13. The customizable tool system of claim 1 wherein the cover slides over the inner frame.
